(19) United States
(12) Patent Application Publication
(10) Pub. No.: US 2019/0171989 A1
(43) Pub. Date: Jun. 6, 2019

(54) Dynamic Workflow Control Based on Database Logic

(71) Applicant: Bank of America Corporation, Charlotte, NC (US)

(72) Inventors: Timothy Smith, Carrollton, TX (US); Daniel J. Serna, Irving, TX (US)

(21) Appl. No.: 15/833,199

(22) Filed: Dec. 6, 2017

(51) Int. Cl. G06Q 10/06; G06F 9/38; G06F 17/30

(52) U.S. Cl. CPC G06Q 10/06316; G06F 9/3836; H04W 84/02; G06F 17/30557; G06F 17/30321

(57) ABSTRACT

Methods, systems, and apparatuses for dynamic workflow control based on database logic are described herein. In some arrangements, a workflow control server may configure a workflow engine based on one or more data tables stored in a workflow database which may comprise a logical arrangement of workflow steps, actions, and transitions. The workflow control server may perform one or more workflow actions corresponding to a workflow step based on one or more triggers provided by a participant computing device. Responsive to performing the one or more workflow actions, the workflow control server may execute the workflow engine to perform a workflow transition between workflow steps.

### FIELD

Aspects described herein generally relate to electrical computers, digital data processing systems, and workflow control. In particular, one or more aspects of the disclosure relate to a dynamic workflow control system driven by alterable database logic.

### BACKGROUND

Many organizations have existing workflow control systems which manage the creation, processing, and transition of work efforts across a plurality of sequenced workflow steps. While such systems are useful resources in providing structure to workflow environments, existing workflow control systems are optimized to execute in static workflow arrangements in which workflow steps, actions, and step transitions are pre-established and finalized by the organizations. When utilized in workflow environments in which workflow steps, actions, and step transitions are in flux and not in a finalized state, however, existing workflow control systems are deficient due to the rigidity hardcoded into the system. For example, many workflow systems operate based on application code which controls the workflow steps, actions, and step transitions. In the event that changes need to be made to the steps, actions, and/or step transitions, the application code may need to be accessed and altered. When such workflow processing systems are implemented in nascent workflow arrangements in which alterations are common, a technological inefficiency arises as each revision may necessitate the changing of the underlying application code of the workflow processing system.

### SUMMARY

Aspects of the disclosure provide effective, efficient, scalable, and convenient technical solutions that address and overcome the technical problems associated with existing workflow control systems optimized to execute in static environments with pre-established workflow steps, actions, and step transitions. In particular, one or more aspects of the disclosure provide for dynamic workflow control based on database logic.

In accordance with one or more embodiments, a workflow control server including one or more processors and memory storing at least a workflow engine and a workflow database may configure the workflow engine based on the workflow database, wherein the workflow database comprises one or more data tables including a logical arrangement of workflow steps, workflow actions, and workflow transitions. The workflow control server may receive, from a first computing device, a work effort request corresponding to a workflow. The workflow control server may cause the first computing device to display a first user interface comprising a plurality of first user interface elements, the first user interface corresponding to a first workflow step of a work effort related to the work effort request and the workflow. The workflow control server may receive, from the first computing device and through the first user interface, a first trigger associated with one or more of the first plurality of user interface elements. Based on the first trigger, the workflow control server may execute the workflow engine to perform at least a first workflow action. Responsive to performing at least the first workflow action, the workflow control server may perform a first workflow transition to progress the work effort from the first workflow step to a second workflow step.

Thereafter, based on performing the first workflow transition to progress the work effort to the second workflow step, the workflow control server may cause a second computing device to display a second user interface comprising a plurality of second user interface elements, the second user interface corresponding to the second workflow step of the work effort related to the work effort request. The workflow control server may receive, from the second computing device and through the second user interface, a second trigger associated with one or more of the second plurality of user interface elements. Based on the second trigger, the workflow control server may execute the workflow engine to perform at least a second workflow action. Responsive to performing at least the second workflow action, the workflow control server may perform a second workflow transition to conclude the work effort in the workflow.

Furthermore, based on performing the second workflow transition to conclude the work effort in the workflow, the workflow control server may cause a third computing device to display a third user interface comprising a plurality of third user interface elements, the third user interface corresponding to a workflow processing assessment interface. The workflow control server may receive, from the third computing device and through the third user interface, a third trigger associated with one or more of the third plurality of user interface elements. Based on the third trigger, the workflow control server may update one or more of the workflow engine and the workflow database.

Additionally, based on the third trigger, the workflow control server may update the logical arrangement of the workflow steps, workflow actions, and workflow transitions of the one or more data tables of the workflow database.

In some embodiments, the memory of the workflow control server may further store a workflow library, and the workflow engine may call operations from the workflow library to perform the first workflow transition and the second workflow transition. Thereafter, based on the third trigger, the workflow control server may update the workflow library and the workflow engine.

In some embodiments, the workflow library may be configured based on the logical arrangement of the workflow steps, workflow actions, and workflow transitions of the one or more data tables of the workflow database.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and in which:

FIG. 1A depicts an illustrative computing environment for dynamic workflow control based on database logic that may be used in accordance with one or more example embodiments described herein;

FIG. 1B depicts an illustrative computing device for dynamic workflow control based on database logic that may be used in accordance with one or more example embodiments described herein;

FIGS. 2A-2D depict an illustrative event sequence for dynamic workflow control based on database logic that may be used in accordance with one or more example embodiments described herein;

FIGS. 3A and 3B depict example data tables for dynamic workflow control based on database logic that may be used in accordance with one or more example embodiments described herein;

FIGS. 4A and 4B depict example programming code for dynamic workflow control based on database logic that may be used in accordance with one or more example embodiments described herein;

FIG. 5 depicts an example of a first graphical user interface for dynamic workflow control based on database logic that may be used in accordance with one or more example embodiments described herein;

FIG. 6 depicts an example of a second graphical user interface for dynamic workflow control based on database logic that may be used in accordance with one or more example embodiments described herein;

FIG. 7 depicts an example of a third graphical user interface for dynamic workflow control based on database logic that may be used in accordance with one or more example embodiments described herein; and

FIG. 8 depicts an illustrative method for dynamic workflow control based on database logic that may be used in accordance with one or more example embodiments described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways. Furthermore, it is noted that various connections between elements are discussed in the following description. It is noted that these connections are general and, unless specified otherwise, may be direct or indirect, wired or wireless, and that the specification is not intended to be limiting in this respect.

As a general introduction to the subject matter described in further detail below, aspects described herein are directed towards apparatuses, systems, and methods for dynamic workflow control based on database logic. A workflow control server may configure a workflow control engine based on logical arrangements between one or more of workflow steps, workflow actions, and workflow transitions stored in a workflow database. The workflow control server may receive a work effort from a participant computing device which may cause the workflow control server to commence workflow control processing at a particular workflow step. At the particular workflow step, the workflow control server may activate and/or control one or more participant computing devices to display one or more user interface elements relating to the workflow effort. Based on responses provided by the one or more participant computing devices through the one or more user interface elements, the workflow control server may perform one or more workflow actions corresponding to the work effort in order to progress the work effort through the workflow. The performance of the workflow actions by the workflow control server may cause the workflow effort to progress through one or more workflow steps of the workflow until the work effort is completed or terminated. By pinning the performance of such processes to logical arrangements between one or more of the workflow steps, workflow actions, and workflow transitions stored in the workflow database, technological improvements may be provided in comparison to existing workflow systems in which the workflow steps, workflow actions, and workflow transitions are hardcoded into the workflow control application. The technological benefits relating to dynamic workflow control based on database logic are described in detail in the discussion provided below.

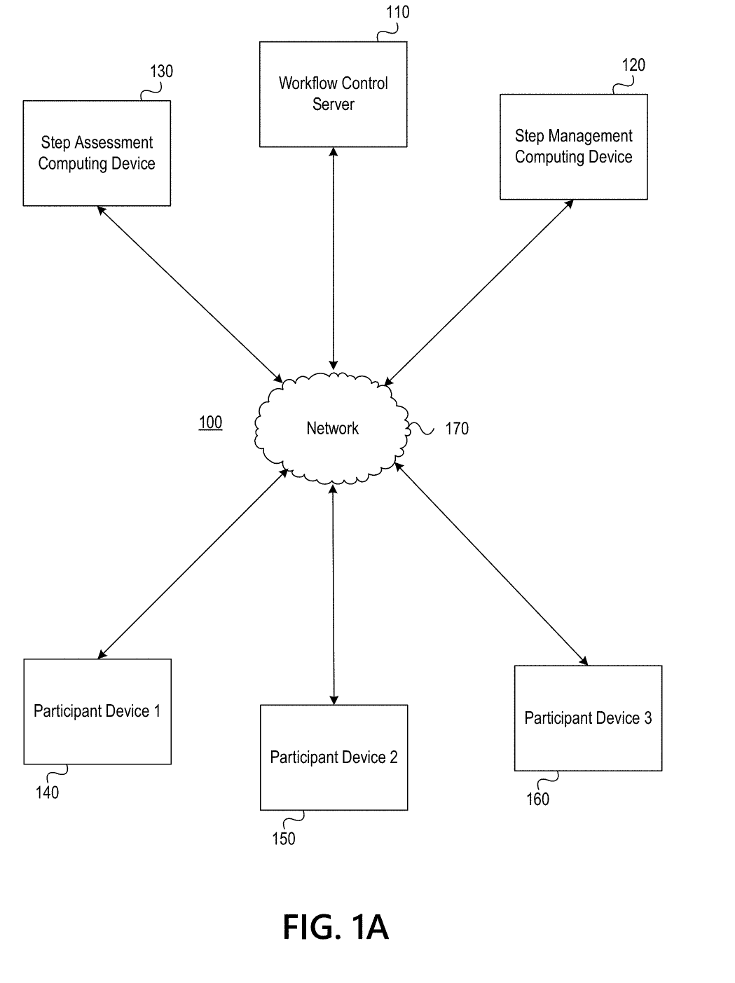

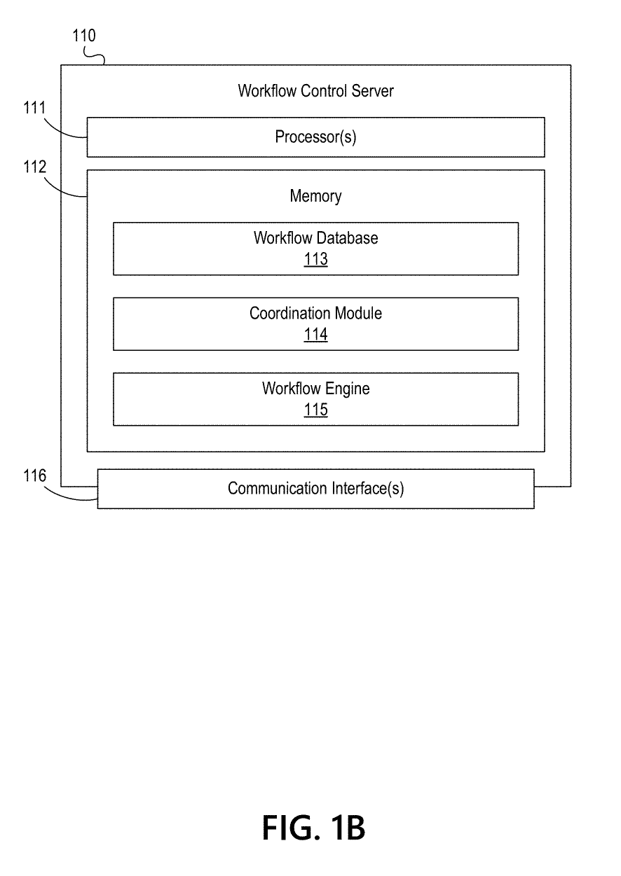

FIG. 1A depicts an illustrative computing environment for dynamic workflow control based on database logic that may be used in accordance with one or more example embodiments described herein. Referring to FIG. 1A, computing environment 100 may include one or more computing devices, platforms, and/or networks. For example, computing environment 100 may include workflow control server 110, step management computing device 120, step assessment computing device 130, first participant computing device 140, second participant computing device 150, third participant computing device 160, and network 170.

Each of workflow control server 110, step management computing device 120, step assessment computing device 130, first participant computing device 140, second participant computing device 150, and third participant computing device 160 may be configured to communicate via and/or otherwise interface through network 170. In particular, step management computing device 120 may be configured to communicate with workflow control server 110 through network 170 in creating and/or updating workflow steps, actions, and/or transitions. Workflow control server 110 may be configured to update one or more data tables stored in a workflow database, based on the communications with step management computing device 120, which may be used to configure a workflow engine. Through execution of the workflow engine, workflow control server 110 may be configured to perform workflow processing corresponding to work efforts through one or more workflow steps. In doing so, workflow control server 110 may activate and/or control one or more of step management computing device 120, step assessment computing device 130, first participant computing device 140, second participant computing device 150, and third participant computing device 160 by way of communications through network 170. In some instances, step assessment computing device 130 may be configured to interface with workflow control server 110 through network 170 to provide feedback regarding the workflow step processing performed by workflow control server 110. Such feedback may be incorporated by workflow control server 110 in order to refine and/or calibrate the workflow engine.

Workflow control server 110 may include a workflow database and a workflow engine stored in memory. The workflow database may comprise one or more data tables which may be used to configure a workflow library, such as a stateless workflow library, that may be referenced by the workflow engine in performing the workflow processing described herein. For example, workflow control server 110 may be configured to control workflow processing across one or more workflow steps. In doing so, workflow control server 110 may be configured to receive work efforts creation requests through communications with one or more of first participant computing device 140, second participant computing device 150, and/or third participant computing device 160. Based on one or more workflow triggers provided by one or more of first participant computing device 140, second participant computing device 150, and/or third participant computing device 160, workflow control server 110 may execute the workflow engine to perform workflow actions related to the work effort and workflow transitions to move through one or more workflow steps relating to the work effort. Responsive to transitioning to a new workflow step, workflow control server 110 may activate and/or control one or more of first participant computing device 140, second participant computing device 150, and third participant computing device 160 by way of communications through network 170 to cause the display of user interface elements related to the work efforts. Workflow control server 110 may be configured to receive workflow triggers through the user interface elements, which may serve as a catalyst for performance of further work flow actions and transitions.

Step management computing device 120 may be configured to interface with one or more of workflow control server 110, step assessment computing device 130, first participant computing device 140, second participant computing device 150, and/or third participant computing device 160 through network 170, and may primarily communicate with workflow control server 110. Step management computing device 120 may be configured to generate one or more workflow steps, actions, and step transitions. The workflow steps, actions, and step transitions may be communicated by step management computing 120 to workflow control server 110, which in turn may store the steps, actions, and/or step transitions in one or more data tables of the workflow database. In some instances, step management computing device 120 may be configured to update and/or delete existing workflow steps, actions, and/or step transitions. The updates and/or deletions may be provided by step management computing device 120 to workflow control server 110 for storage in the one or more data tables of the workflow database.

Step assessment computing device 130 may be configured to interface with one or more of workflow control server 110, step management computing device 120, first participant computing device 140, second participant computing device 150, and/or third participant computing device 160 through network 170, and may primarily communicate with workflow control server 110. Step assessment computing device 130 may be configured to assess workflow step processing performed by workflow control server 110. For example, step assessment computing device 130 may be configured to receive workflow step processing information from one or more of workflow control server 110, step management computing device 120, first participant computing device 140, second participant computing device 150, and/or third participant computing device 160 through network 170. A user of step assessment computing device 130 may be able to review the workflow processing information in order to provide feedback to workflow control server 110. As stated above, the feedback may be incorporated by workflow control server 110 in order to refine and/or calibrate the workflow engine of workflow control server 110.

First participant computing device 140, second participant computing device 150, and third participant computing device 160 may be configured to communicate with each other through network 170, as well as with workflow control server 110, step management computing device 120, and step assessment computing device 130. Each of first participant computing device 140, second participant device 150, and third participant device 160 may be configured to generate work efforts creation requests associated with specific work efforts related to workflows of computing environment 100. In particular, first participant computing device 140, second participant device 150, and/or third participant device 160 may be configured to create work efforts creation requests in a workflow processing system coordinated by workflow control server 110 and initialize and/or transmit the workflow efforts creation requests to workflow control server 110. Furthermore, each of first participant computing device 140, second participant device 150, and third participant device 160 may be configured to be controlled and/or activated by workflow control server 110 during performance of workflow processing. In particular, responsive to receiving commands embedded in one or more digital signals from workflow control server 110, each of first participant computing device 140, second participant device 150, and third participant device 160 may be configured to display user interfaces comprising a plurality of user interface elements which serve to present information related to the workflow processing. Through interactions with the user interface elements, each of first participant computing device 140, second participant device 150, and third participant device 160 may be configured to transmit workflow triggers to workflow control server 110 which may further workflow processing.

Computing environment 100 also may include one or more networks, which may interconnect one or more of workflow control server 110, step management computing device 120, step assessment computing device 130, first participant computing device 140, second participant computing device 150, and third participant computing device 160. For example, computing environment 100 may include network 170, which may be a private and/or public network. Network 170 may include one or more sub-networks (e.g., local area networks (LANs), wide area networks (WANs), or the like). In instances in which network 170 is configured as a private network, network 170 may be associated with a particular organization (e.g., a corporation, financial institution, educational institution, governmental institution, or the like) and may interconnect one or more computing devices associated with the organization. For example, workflow control server 110, step management computing device 120, step assessment computing device 130, first participant computing device 140, second participant computing device 150, and third participant computing device 160 may be associated with an organization (e.g., a financial institution), and network 170 may be associated with and/or operated by the organization, and may include one or more networks (e.g., LANs, WANs, virtual private networks (VPNs), or the like) that interconnect workflow control server 110, step management computing device 120, step assessment computing device 130, first participant computing device 140, second participant computing device 150, third participant computing device 160, and one or more other computing devices and/or computer systems that are used by, operated by, and/or otherwise associated with the organization.

FIG. 1B depicts an illustrative computing device (e.g., workflow control server 110) for dynamic workflow control based on database logic that may be used in accordance with one or more example embodiments described herein. Referring to FIG. 1B, workflow control server 110 may include one or more processor(s) 111, memory 112, and communication interface(s) 116. A data bus may interconnect processor(s) 111, memory 112, and communication interface(s) 116. Communication interface(s) 116 may be a network interface configured to support communication between workflow control server 110 and one or more networks (e.g., network 170 or the like). Memory 112 may include one or more program modules, engines, and/or libraries having instructions that when executed by processor(s) 111 cause workflow control server 110 to perform one or more functions described herein, and/or one or more databases that may store and/or otherwise maintain information which may be used by such program modules, engines, libraries, and/or processor(s) 111. In some instances, the one or more program modules, engines, libraries, and/or databases may be stored by and/or maintained in different memory units of workflow control server 110 and/or by different computing devices that may form and/or otherwise make up workflow control server 110. For example, memory 112 may have, store, and/or include workflow database 113, coordination module 114, and workflow engine 115.

Workflow database 113 may store either a data table or plurality of data tables which may comprise information related to workflow steps, actions, and step transitions for workflows corresponding to work efforts identified in corresponding work efforts creation requests provided by one or more of first participant computing device 140, second participant computing device 150, and third participant computing device 150. In particular, the information related to the workflow steps, actions, and step transitions stored the date table may provide a logical framework for the execution of the workflow control processes described herein. For example, the information corresponding to the workflow steps, actions, and/or step transitions may provide a logical interrelation between each of the workflow steps, each of the one or more workflow actions corresponding to each of the workflow steps, and each of the workflow transitions corresponding to each of the workflow actions. In some instances, the information corresponding to the workflow steps, actions, and/or step transitions may further provide a logical linkage with one or more of workflow control server 110, step management computing device 120, step assessment computing device 130, first participant computing device 140, second participant computing device 150, and third participant computing device 160. In such instances, particular workflow steps may be associated with a particular computing device of workflow control server 110, step management computing device 120, step assessment computing device 130, first participant computing device 140, second participant computing device 150, and third participant computing device 160.

In some instances, workflow database 113 may store a plurality of data tables which respectively store information related to the workflow steps, actions, and step transitions. For instance, a first data table of workflow database 113 may store information related to the workflow steps, a second data table of workflow database 113 may store information related to workflow actions, and a third data table of workflow database 113 may store information related to workflow transitions. In such instances, each of the respective data tables may be cross-referencing.

Cooperation module 114 may store one or more programs and/or computer-executable instructions which, when executed, cause workflow control server 110 to interface with one or more of step management computing device 120, step assessment computing device 130, first participant computing device 140, second participant computing device 150, and third participant computing device 160. In particular, cooperation module 114 may cause workflow control server 110 to transmit and receive data with one or more of step management computing device 120, step assessment computing device 130, first participant computing device 140, second participant computing device 150, and third participant computing device 160 for developing and maintaining workflow database 113 and/or refining, calibrating, and/or optimizing workflow engine 115. For example, cooperation module 114 may handle requests from step management computing device 120 related to creating, generating, revising, and/or updating workflow steps, workflow actions, and/or workflow step transitions. Cooperation module 114 may further handle updating workflow database 113 based on the requests provided by step management computing device 120. Furthermore, cooperation module 114 may handle feedback provided by step assessment computing device 130 for refining, calibrating, and/or optimizing workflow engine 115. Based on the feedback, cooperation module 114 may alter how workflow engine 115 performs the workflow processing, as described in further detail below.

Workflow engine 115 may include one or more libraries, applications, programs, and/or methods which drive execution of the workflow processing of workflow actions and workflow transitions corresponding to work efforts identified in corresponding work efforts requests provided by one or more of first participant computing device 140, second participant computing device 150, and third participant computing device 150 as described herein. In particular, workflow engine 115 may handle work effort creation requests from one or more of first participant computing device 140, second participant computing device 150, and third participant computing device 160. Based on the work effort creation requests, workflow engine 115 may commence the workflow processing corresponding to the work effort creation requests at particular workflow steps in workflows related to the work efforts of the work flow creation requests. Workflow engine 115 may cause workflow control server 110 to activate and/or control one or more of first participant computing device 140, second participant computing device 150, and third participant computing device 160 to cause display of user interfaces related to the work efforts and corresponding to the workflow steps. Workflow engine 115 may be configured to handle triggers provided by one or more of first participant computing device 140, second participant computing device 150, and third participant computing device 160 through the displayed user interfaces. In particular, workflow engine 115 may perform workflow actions and/or workflow transitions based on the triggers provided through the displayed user interfaces, and such actions and/or transitions may cause the workflow processing to progress. Such processes, in addition to others described in further detail below, may be performed by workflow engine 115 until the workflow steps corresponding to the work efforts are completed or terminated.

In order to perform the processes described above, workflow engine 115 may be configured based on the data table or plurality of data tables stored in workflow database 113. In particular, one or more methods of workflow engine 115 may configure a workflow library of workflow engine 115 based on the data table or plurality of data tables stored in workflow database 113. The one or more applications, programs, and/or methods of workflow engine 115 may call to the workflow library in performing the workflow actions and workflow transitions. By configuring the workflow engine 115 based on the logical relationships defined in the data table or plurality of data tables of workflow database 113, the workflow processing performed by workflow control server 110 may provide technological benefits in comparison to existing workflow control systems optimized to execute in static workflow arrangements in which workflow steps, actions, and transitions are pre-established. For example, changes to the workflow steps, actions, and transitions may be made through the logical relationships defined in the data table or plurality of data tables of workflow database 113 as opposed to the workflow control intelligence comprised in workflow engine 115. Accordingly, the workflow control processing performed by workflow control server 110 may be altered by making changes to the data detailing the logical relationships stored in workflow database 113, rather than the code detailing the workflow control intelligence comprised in workflow engine 115. By creating the ability to update workflows without making coding changes, workflow control server 110 and the underlying intelligence may be implemented in workflow environments undergoing significant overhauling of workflow steps, actions, and transitions in an efficient and scalable manner.

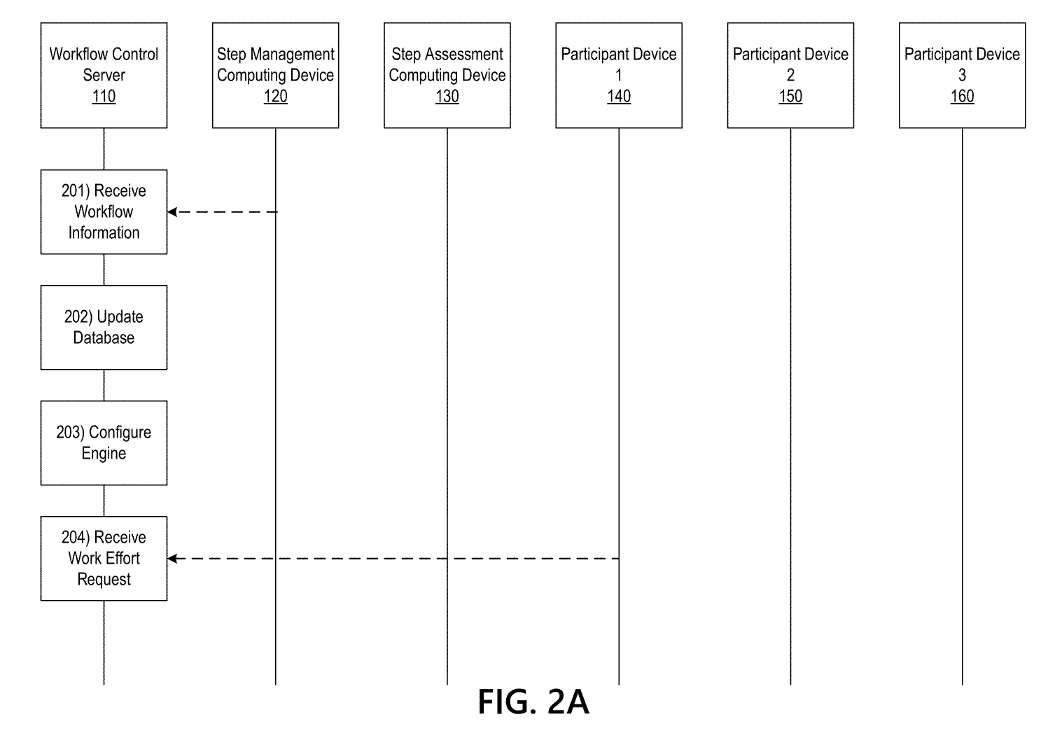

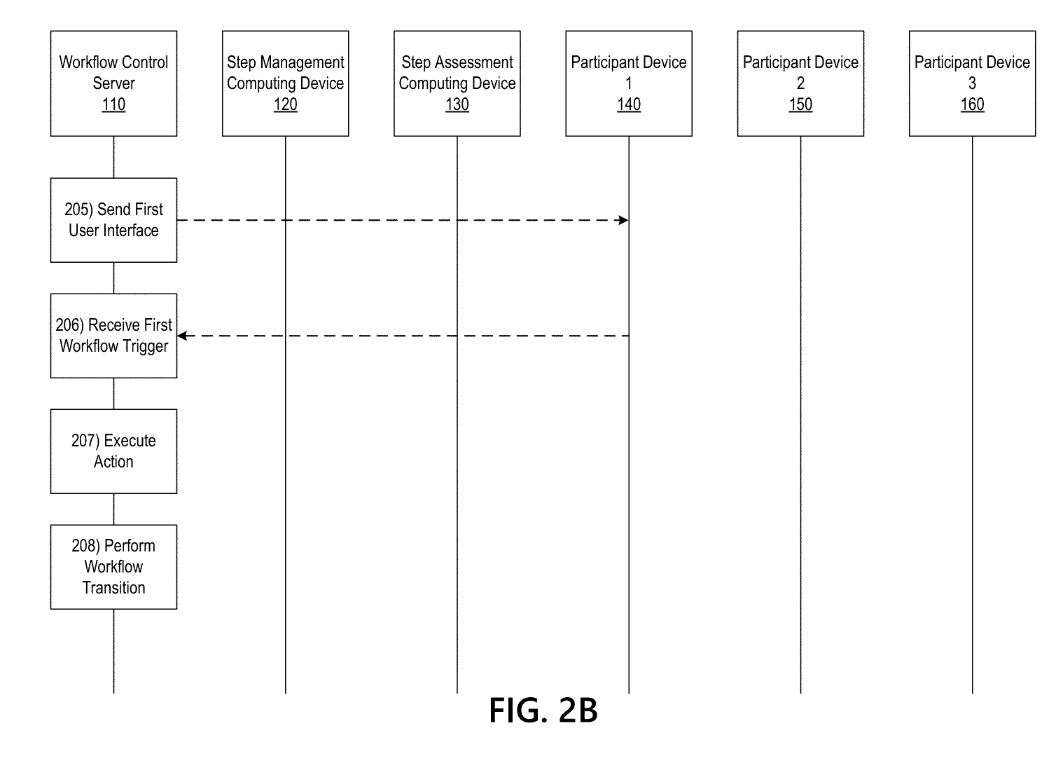

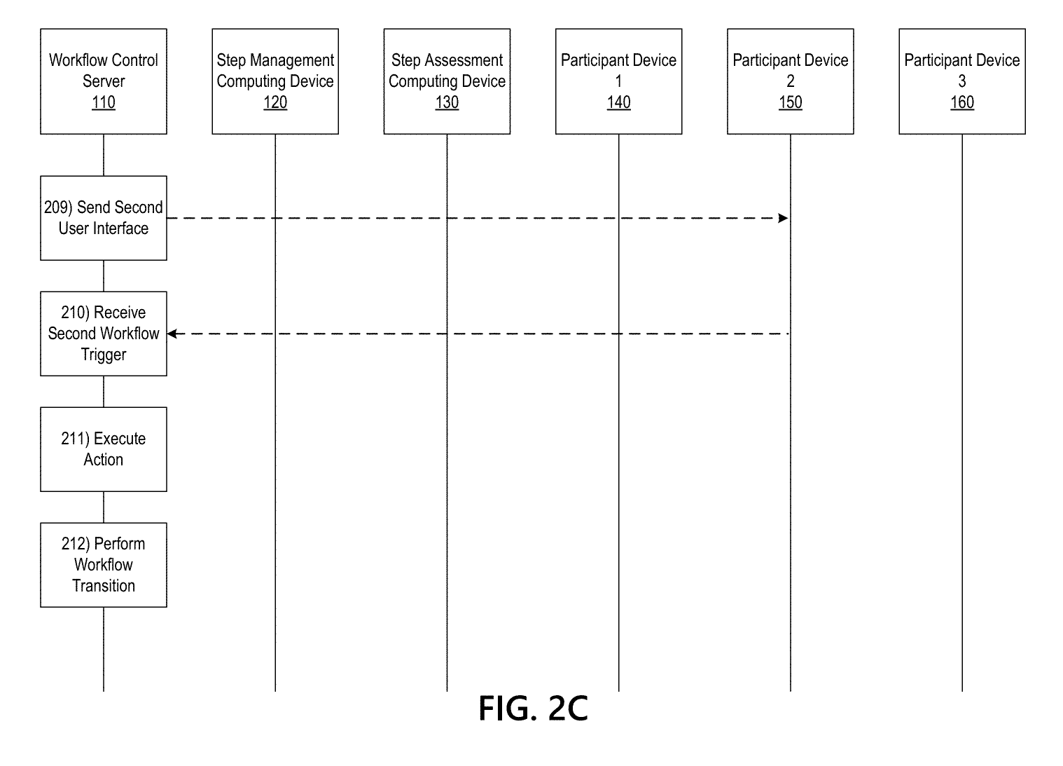

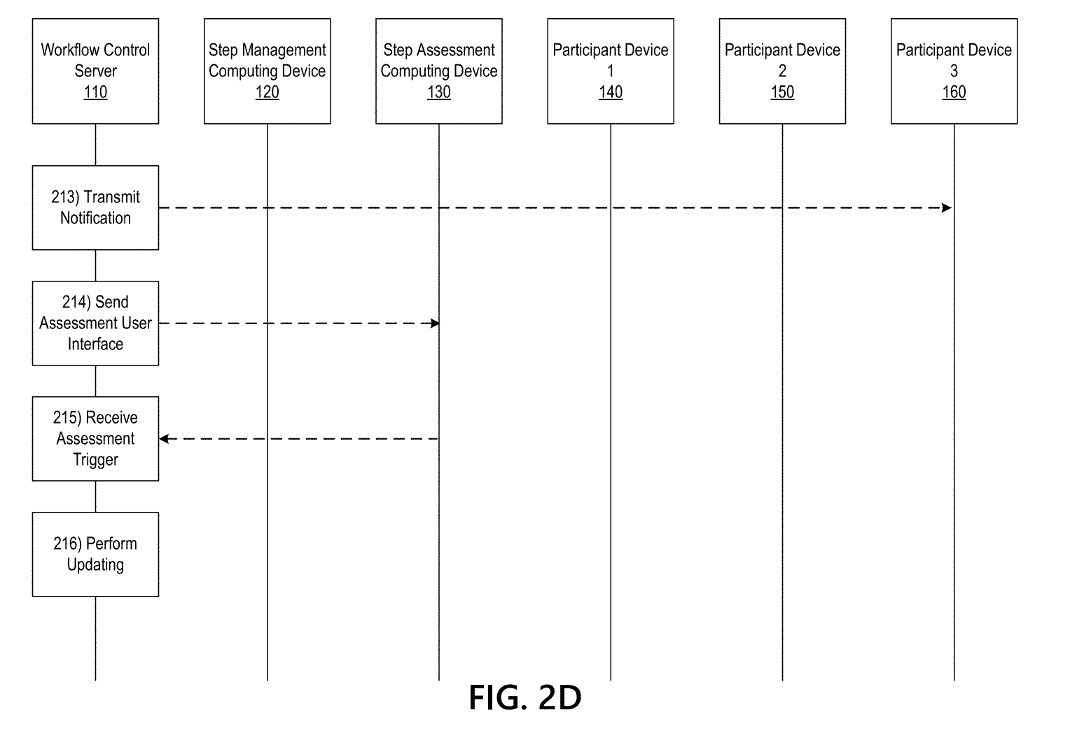

FIGS. 2A-2D depict an illustrative event sequence for dynamic workflow control based on database logic that may be used in accordance with one or more example embodiments described herein. While the steps of the event sequence of FIGS. 2A-2D are described in a particular order, it should be understood that the steps may be performed in any order without departing from the scope of the disclosure provided herein. Furthermore, even though the event sequence is described as being performed by a particular arrangement of computing devices and computer networks (e.g., workflow control server 110, step management computing device 120, step assessment computing device 130, first participant computing device 140, second participant computing device 150, third participant computing device 160, and network 170), the processes may be performed by a number of computing devices and/or computing networks greater or less than that described in regard to FIGS. 2A-2D.

Referring to FIG. 2A, at step 201, workflow control server 110 may receive workflow information from step management computing device 120. The workflow information received from step management computing device 120 may include new workflow steps, workflow actions, and/or workflow transitions in relation to an existing workflow for an existing work effort type and/or in relation to a new workflow for a new work effort type. Additionally and/or alternatively, the workflow information may include changes and/or deletions to existing workflow steps, workflow actions, and/or workflow transitions in relation to an existing workflow for an existing work effort type.

At step 202, workflow control server 110 may update workflow database 113 based on the workflow information received from step management computing device 120. In particular, coordination module 114 may cause workflow control server 110 to update the data table or the plurality of data tables of workflow database 113 with the workflow information. In instances in which the workflow information received from step management computing device 120 includes new workflow steps, workflow actions, and/or workflow transitions in relation to an existing workflow for an existing work effort type, coordination module 114 may cause workflow control server 110 to create one or more new entries in the data table or the plurality of data tables of workflow database 113 corresponding to the new workflow steps, workflow actions, and/or workflow transitions. In instances in which the workflow information received from step management computing device 120 includes new workflow steps, workflow actions, and/or workflow transitions in relation to a new workflow for a new work effort type, coordination module 114 may cause workflow control server 110 to create a new workflow in workflow database 113, associate the new workflow with the new work effort type, and create one or more new entries in the data table or the plurality of data tables of workflow database 113 corresponding to the new workflow steps, workflow actions, and/or workflow transitions. In the event that the workflow information includes changes and/or deletions to existing workflow steps, workflow actions, and/or workflow transitions in relation to an existing workflow for an existing work effort type, coordination module 114 may cause workflow control server 110 to replicate the changes and/or deletions stipulated in the workflow information to the existing workflow steps, workflow actions, and/or workflow transitions stored in the data table or the plurality of data tables of workflow database 113.

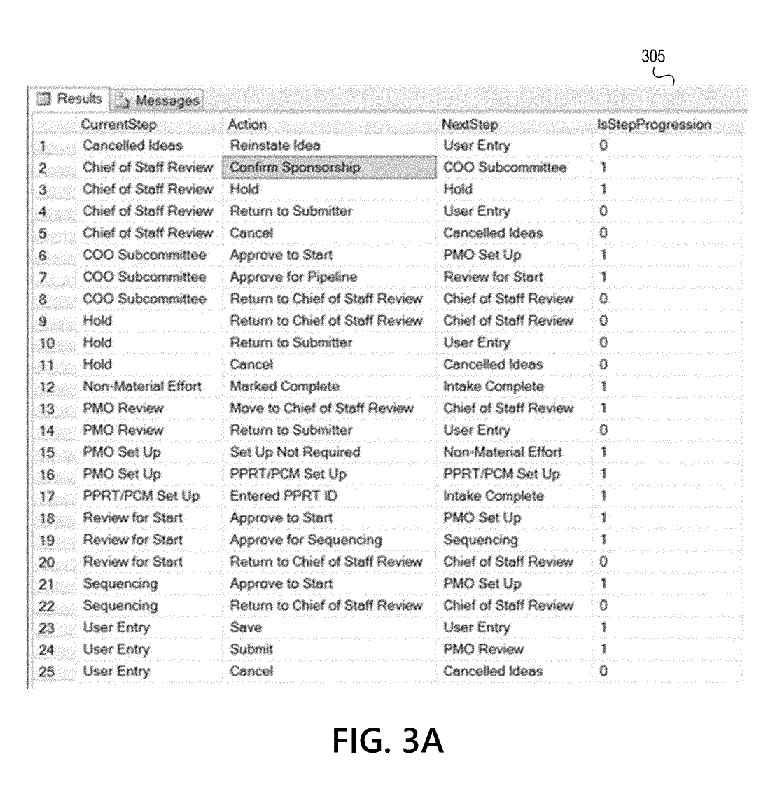

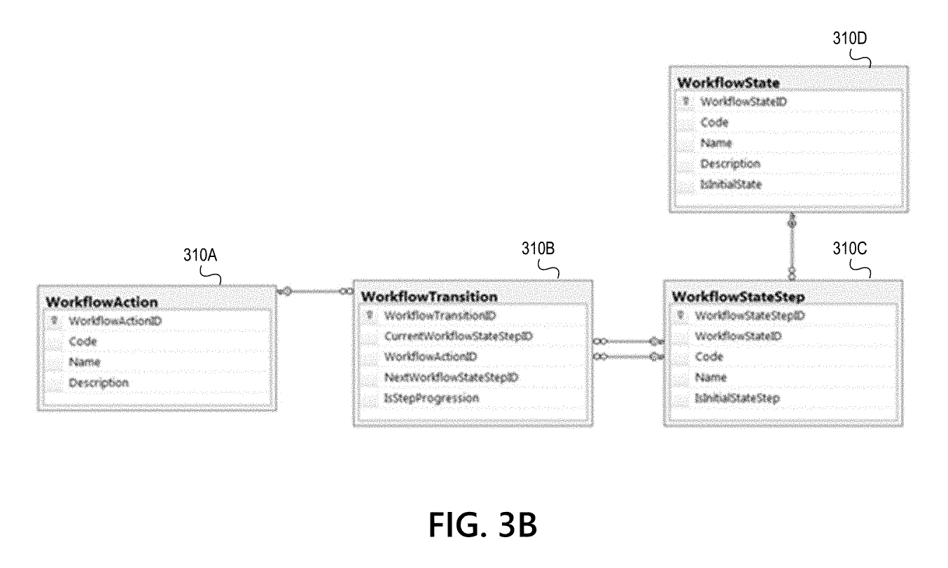

In further detail, FIG. 3A depicts an example configuration of workflow database 113 in an arrangement comprising single data table 305, which may include a plurality of columns and rows detailing information related to the workflow steps, workflow actions, and/or workflow transitions. For example, the plurality of columns may include a first column dedicated to workflow steps (e.g., “CurrentStep”), a second column dedicated to workflow actions (e.g., “Action”), and third and fourth columns dedicated to workflow transitions (e.g., respectively “NextStep” and “IsStepProgression”). The plurality of rows may be arranged in relation to the workflow actions possible for any given workflow step. In instances in which the workflow information received from step management computing device 120 includes new workflow steps, workflow actions, and/or workflow transitions in relation to an existing workflow for an existing work effort type, coordination module 114 may cause workflow control server 110 to create one or more new entries in single data table 305 corresponding to the new workflow steps, workflow actions, and/or workflow transitions. In instances in which the workflow information received includes new workflow steps, workflow actions, and/or workflow transitions in relation to a new workflow for a new work effort type, coordination module 114 may cause workflow control server 110 to create a new workflow in workflow database 113, associate the new workflow with the new work effort type, and create one or more new entries in single data table 305 corresponding to the new workflow steps, workflow actions, and/or workflow transitions. In the event that the workflow information includes changes and/or deletions to existing workflow steps, workflow actions, and/or workflow transitions in relation to an existing workflow for an existing work effort type, coordination module 114 may cause workflow control server 110 to replicate the changes and/or deletions stipulated in the workflow information to the existing workflow steps, workflow actions, and/or workflow transitions stored in single data table 305.

In arrangements in which workflow database 113 includes a plurality of data tables, further discussion is provided in relation to FIG. 3B, which depicts an example configuration of workflow database 113 comprising the plurality of data tables (e.g., 310A, 310B, 310C, and 310D). Data tables 310A-310D may be respectively associated with workflow steps, workflow actions, and/or workflow transitions. In particular, data table 310A (e.g., “WorkflowAction” data table) may be associated with workflow actions, data table 310B (e.g., “WorkflowTransition” data table) may be associated with workflow transitions, and data tables 310C (e.g., “WorkflowStateStep” data table) and 310D (e.g., “WorkflowState” data table) may be associated workflow steps. Each of data tables 310A, 310B, 310C, and 310D may be cross-referencing based on data element overlap. In instances in which the workflow information received from step management computing device 120 includes new workflow steps, workflow actions, and/or workflow transitions in relation to an existing workflow for an existing work effort type, coordination module 114 may cause workflow control server 110 to create one or more new entries in data tables 310A-310D in relation to the new workflow steps, workflow actions, and/or workflow transitions. In instances in which the workflow information received includes new workflow steps, workflow actions, and/or workflow transitions in relation to a new workflow for a new work effort type, coordination module 114 may cause workflow control server 110 to create a new workflow in workflow database 113, associate the new workflow with the new work effort type, and create one or more new entries in data tables 310A-310D corresponding to the new workflow steps, workflow actions, and/or workflow transitions. In the event that the workflow information includes changes and/or deletions to existing workflow steps, workflow actions, and/or workflow transitions in relation to an existing workflow for an existing work effort type, coordination module 114 may cause workflow control server 110 to replicate the changes and/or deletions stipulated in the workflow information to the existing workflow steps, workflow actions, and/or workflow transitions stored in data tables 310A-310D.

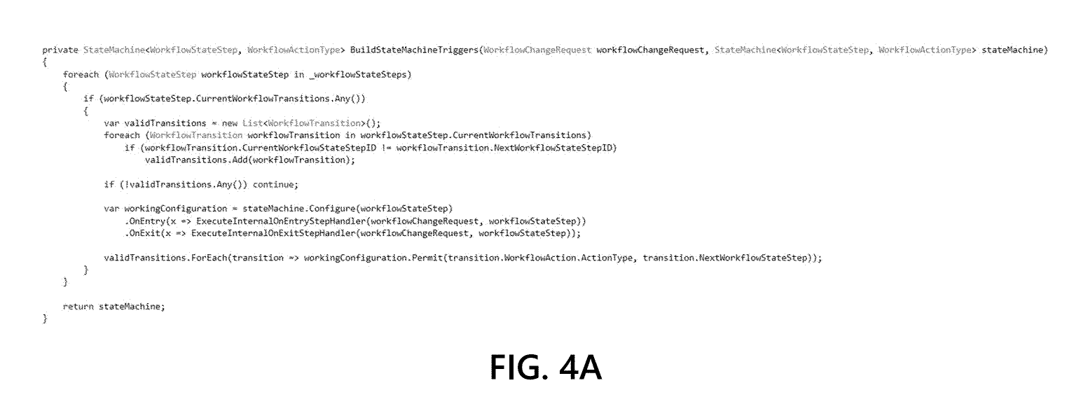

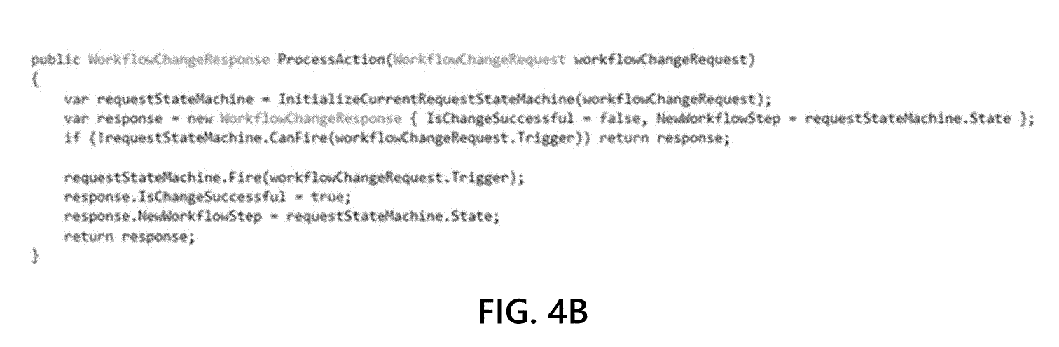

Referring back to FIG. 2A, at step 203, workflow control server 110 may configure workflow engine 115 based on the data table or the plurality of data tables of workflow database 113. In particular, and as stated above, workflow control server 110 may execute one or more methods of workflow engine 115 to configure a workflow library of workflow engine 115 based on the data table or the plurality of data tables of workflow database 113. In further detail, FIG. 4A depicts example programming code for configuring a workflow library based on the one or more data tables. In particular, FIG. 4A depicts example programming code for a method for configuring a workflow library of workflow engine 115 based on the data table or the plurality of data tables of workflow database 113. As shown in FIG. 4A, the code details a method (e.g., “BuildStateMachineTriggers” method) that utilizes the data table depicted in FIG. 3A and/or the plurality of data tables depicted in FIG. 3B to configure the workflow library of workflow engine 115 with valid workflow transitions. The method may cause workflow control server 110 to assess each workflow step stored in the data table and/or plurality of data tables of workflow engine 115 and identify workflow steps which undergo workflow transitions responsive to the performance of corresponding workflow actions. Identified workflow steps may be classified as involving valid workflow transitions.

At step 204, workflow control server 110 may receive a work effort creation request from first participant computing device 140. In some instances, the work effort creation request may be received from any of first participant computing device 140, second participant computing device 150, and third participant computing device 160. The work effort creation request may be received at workflow control server 110 through a workflow application operating on first participant computing device 140 configured to interface with workflow control server 110. Additionally and/or alternatively, the work effort creation request may be received at workflow control server 110 from first participant computing device 140 through a URL and/or web interface associated with workflow control server 110.

The work effort creation request may be for the initiation of a work effort related to a particular task which may be comprised of a plurality of workflow steps requiring actions to be performed by one or more of workflow control server 110, step management computing device 120, step assessment computing device 130, first participant computing device 140, second participant computing device 150, and/or third participant computing device 160. The work effort creation request received by workflow control server 110 may include information such as an indication of work effort type, selection of one or more workflow steps, and/or one or more deadlines for completion of the work effort and/or completion of the one or more selected workflow steps relating to the work effort.

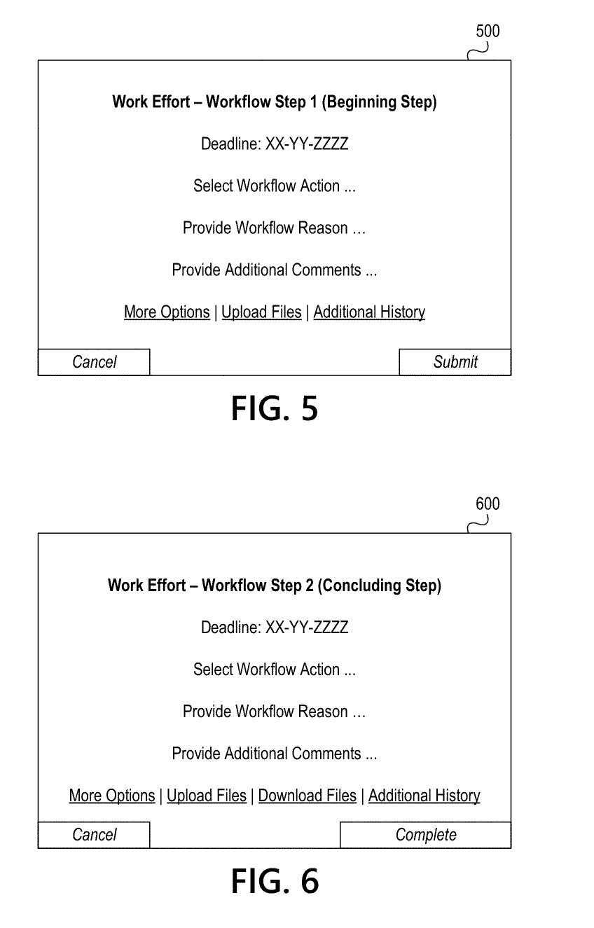

Referring to FIG. 2B, at step 205, workflow control server 110 may send a first user interface to first participant computing device 140 based on the work effort creation request provided by participant computing device 140, which may mark the commencement of the workflow at a first workflow step relating to the work effort indicated by the work effort creation request. In some instances, the first workflow step relating to the work effort may be the beginning workflow step in the workflow. In sending the first user interface to first participant computing device 140, workflow control server 110 may cause first participant computing device 140 to display and/or otherwise present the first user interface. For example, in sending the first user interface to first participant computing device 140, workflow control server 110 may cause first participant computing device 140 to display and/or otherwise present a graphical user interface similar to graphical user interface 500, which is illustrated in FIG. 5, corresponding to the first workflow step. As seen in FIG. 5, graphical user interface 500 may include one or more fields, controls, and/or other user interface elements that may allow a user of first participant computing device 140 to select a workflow action corresponding to the work effort and the first workflow step to be performed by event workflow control server 110. For example, graphical user interface 500 may include one or more fields, controls, and/or other user interface elements that may allow a user of first participant computing device 140 to specify and/or otherwise select a workflow action to be performed by workflow control server 110, provide a reason for the selecting the workflow action, and/or provide additional comments related to the work effort. Furthermore, graphical user interface 500 may include actionable user interface elements such allow the user of first participant computing device 140 to view more options, upload files, and/or view additional history concerning the work effort and workflow processing relating to the work effort.

In addition, and as seen in FIG. 5, graphical user interface 500 may include one or more other user interface elements, such as buttons “cancel” and “submit,” that, if selected by a user of first participant computing device 140, may cause first participant computing device 140 to either close graphical user interface 500 or provide the selected workflow action, provided reason for the selected workflow action, and/or provided additional comments related to the work effort to workflow control server 110. Workflow control server 110 may subsequently use such information in progressing through various workflow steps of the workflow relating to the work effort.

Referring back to FIG. 2B, at step 206, workflow control server 110 may receive a workflow trigger from first participant computing device 140 through one or more user interface elements of the first provided user interface. For example, in reference to FIG. 5, the workflow trigger may comprise a selection of the “submit” button, which may cause workflow control server 110 to receive the selected workflow action, provided reason for the selected workflow action, and/or provided additional comments related to the work effort from first participant computing device 140.

At step 207, workflow control server 110 may execute the received selected workflow action based on the received workflow trigger from first participant computing device 140. In particular, workflow engine 115 may cause workflow control server 110 to perform the selected workflow action. In the event that the performed workflow action does not cause a workflow transition to a next (e.g., second) workflow step, workflow control server 110 may wait for an additional workflow trigger from first participant computing device 140 that includes a selected workflow action causing a workflow transition. In cases where the workflow processing remains associated with first participant computing device 140 and/or a user of first participant computing device 140, workflow control server 110 may provide additional user interfaces to first participant computing device 140 in response to deadline flags for transitioning from the first workflow step.

At step 208, in the event that the performed workflow action causes a workflow transition to the second workflow step, workflow control server 110 may perform the workflow transition associated with the performed workflow action. In particular, workflow engine 115 may cause workflow control server 110 to execute an application and/or program of workflow engine 115 in order to perform the workflow transition from the first workflow step to the second workflow step. In further detail, FIG. 4B depicts example programming code for performing a workflow transition based on the one or more data tables. In particular, FIG. 4B depicts example programming code for a method, which can be executed by one or more consuming applications and/or programs, to call into the workflow library of workflow engine 115 configured with the valid workflow transitions.

In performing the workflow transition, workflow engine 115 may cause workflow control server 110 to execute a consuming application and/or program responsible for handling the workflow transition. Responsive to execution, the consuming application and/or program may in turn execute the method represented in FIG. 4B. Through execution of the method of FIG. 4B, the consuming application and/or program may call into the workflow library configured with the valid workflow transitions at step 203 based on the workflow action corresponding to the workflow step. The consuming application and/or program of workflow engine 115 may execute one or more functions stored in the workflow library, by calling into the workflow library through execution of the method of FIG. 4B, that correspond to the workflow transition interlinked with the workflow action executed at step 207.

Referring to FIG. 2C, at step 209, workflow control server 110 may send a second user interface to second participant computing device 150 based on the workflow transition. In sending the second user interface to second participant computing device 150, workflow control server 110 may cause second participant computing device 150 to display and/or otherwise present the user interface. In some instances, the second workflow step may be the concluding workflow step. For example, in sending the second user interface to second participant computing device 150, workflow control server 110 may cause second participant computing device 150 to display and/or otherwise present a graphical user interface similar to graphical user interface 600, which is illustrated in FIG. 6, corresponding to the second workflow step. As seen in FIG. 6, graphical user interface 600 may include one or more fields, controls, and/or other user interface elements that may allow a user of second participant computing device 150 to select a workflow action corresponding to the work effort and the second workflow step to be performed by event workflow control server 110. For example, graphical user interface 600 may include one or more fields, controls, and/or other user interface elements that may allow a user of second participant computing device 150 to specify and/or otherwise select a workflow action, provide a reason for the selected workflow action, and/or provide additional comments related to the work effort, as well as allow the user to view more options, upload files, download files, and/or view additional history concerning the work effort and workflow processing of the work effort. In addition, and as seen in FIG. 6, graphical user interface 600 may include one or more other user interface elements, such as buttons “cancel” and “complete,” that, if selected by a user of second participant computing device 150, may cause second participant computing device 150 to either close graphical user interface 600 or provide the selected workflow action, provided reason for the selected workflow action, and/or provided additional comments related to the work effort to workflow control server 110.

At step 210, workflow control server 110 may receive a workflow trigger from second participant computing device 150 through one or more user interface elements of the second provided user interface. For example, in reference to FIG. 6, the workflow trigger may comprise a selection of the “complete” button, which may cause workflow control server 110 to receive the selected workflow action, provided reason for the selected workflow action, and/or provided additional comments related to the work effort from second participant computing device 150.

At step 211, workflow control server 110 may execute the received selected workflow action based on the received workflow trigger from second participant computing device 150. In particular, workflow engine 115 may cause workflow control server 110 to perform the selected workflow action. In the event that the performed workflow action does not cause a workflow finalization transition, such as transmitting a notification to third participant computing device 160, workflow control server 110 may wait for an additional workflow trigger from second participant computing device 150 that includes a selected workflow action causing a workflow finalization. In cases where the workflow processing remains associated with second participant computing device 150 and/or a user of second participant computing device 150, workflow control server 110 may provide additional user interfaces to second participant computing device 150 in response to deadline flags for transitioning from the second workflow step. In some instances, the performed workflow action may correspond to a regressive workflow transition which may transition workflow processing to previously performed workflow step corresponding to the workflow action. In such instances, workflow processing of the work effort may continue as described herein until conclusion of the workflow steps of the work effort and/or termination of the workflow processing.

At step 212, in the event that the performed workflow action causes a workflow finalization transition, such as transmitting a notification to third participant computing device 160, workflow control server 110 may perform the workflow finalization transition associated with the workflow action. In particular, workflow engine 115 may cause workflow control server 110 to execute an application and/or program corresponding to workflow engine 115 to perform the workflow finalization transition. In performing the workflow finalization transition, workflow engine 115 may cause workflow control server 110 to execute a consuming application and/or program responsible for handling the workflow transition. Responsive to execution, the consuming application and/or program may in turn execute the method represented in FIG. 4B. Through execution of the method of FIG. 4B, the consuming application and/or program may call into the workflow library configured with the valid workflow transitions at step 203. By calling into the workflow library, the consuming application and/or program of workflow engine 115 may execute one or more functions stored in the workflow library that correspond to the workflow finalization transition interlinked with the workflow action executed at step 211.

Referring to FIG. 2D, at step 213, workflow control server 110 may transmit a notification to third participant computing device 160 responsive to completion of the workflow processes related to the work effort. In some instances, the notification may include any of a financial transfer, email message, phone call, text message, hardware operation command, and so on.

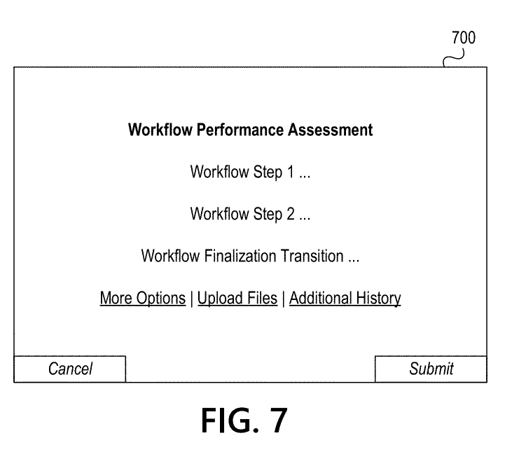

At step 214, workflow control server 110 may send a third user interface to step assessment computing device 130 based on the workflow finalization transition. In sending the third user interface to step assessment computing device 130, workflow control server 110 may cause step assessment computing device 130 to display and/or otherwise present the user interface. For example, in sending the third user interface to step assessment computing device 130, workflow control server 110 may cause step assessment computing device 130 to display and/or otherwise present a graphical user interface similar to graphical user interface 700, which is illustrated in FIG. 7. As seen in FIG. 7, graphical user interface 700 may include one or more fields, controls, and/or other user interface elements that may allow a user of step assessment computing device 130 to provide feedback regarding the workflow control processes performed by workflow control server 101 on a step by step basis. For example, graphical user interface 700 may include one or more fields, controls, and/or other user interface elements that may allow a user of step assessment computing device 130 to provide feedback in relation to the workflow steps, actions, and/or transitions for each workflow step, action, and/or transition performed by workflow control server 110 during performance of the workflow control processes. In particular, third graphical user interface 700 may create a logical linkage represented by one or more user interface elements between each of the workflow steps, actions, and/or transitions with one or more of the databases and/or plurality of databases of workflow database 113, and the workflow library of workflow engine 115. Through interactions with the one or more user interface elements, a user of step assessment computing device 130 may be able to dynamically recalibrate and/or reconfigure one or more of the workflow steps, actions, and/or transitions after each iterative performance of the workflow control processes corresponding to the work effort. In doing so, the workflow processes of nascent workflows may be able to be tested, adjusted, and updated in a simplistic manner, thereby increasing the efficiency and flexibility of workflow control server 110 in handling yet to be finalized workflows.

At step 215, workflow control server 110 may receive an assessment trigger from step assessment computing device 130 through one or more user interface elements of graphical user interface 700. For example, in reference to FIG. 7, the assessment trigger may comprise a selection of the “complete” button, which may cause workflow control server 110 to receive the selected feedback corresponding to one or more of the workflow steps, actions, and/or transitions from step assessment computing device 130. At step 216, based on the selected feedback corresponding to the workflow steps, actions, and/or transitions received from step assessment computing device 130, workflow control server 110 may update the workflow steps, actions, and/or transitions. In particular, workflow control server 110 may update the data table and/or plurality of data tables of workflow database 113 and/or the workflow library of workflow engine 215.

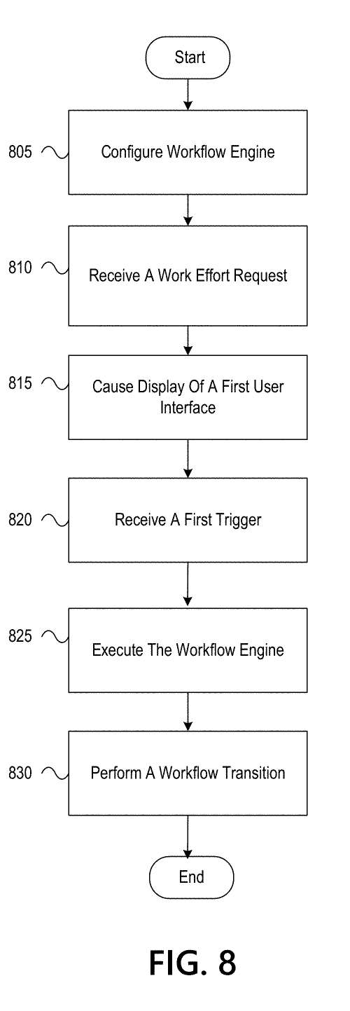

FIG. 8 depicts an illustrative method for dynamic workflow control based on database logic that may be used in accordance with one or more example embodiments described herein. Referring to FIG. 8, at step 805, a workflow control server including one or more processors and memory storing at least a workflow engine and a workflow database may configure the workflow engine based on the workflow database, wherein the workflow database comprises one or more data tables including a logical arrangement of workflow steps, workflow actions, and workflow transitions. At step 810, the workflow control server may receive, from a first computing device, a work effort request corresponding to a workflow. At step 815, the workflow control server may cause the first computing device to display a first user interface comprising a plurality of first user interface elements, the first user interface corresponding to a first workflow step of a work effort related to the work effort request and the workflow. At step 820, the workflow control server may receive, from the first computing device and through the first user interface, a first trigger associated with one or more of the first plurality of user interface elements. At step 825, based on the first trigger, the workflow control server may execute the workflow engine to perform at least a first workflow action. At step 830, responsive to performing at least the first workflow action, the workflow control server may perform a first workflow transition to progress the work effort from the first workflow step to a second workflow step.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A workflow control server, including:
one or more processors; and
memory storing at least a workflow engine, a workflow database, and computer-readable instructions that, when executed by the one or more processors, cause the workflow control server to:
configure the workflow engine based on the workflow database, wherein the workflow database comprises one or more data tables including a logical arrangement of workflow steps, workflow actions, and workflow transitions;
receive, from a first computing device, a work effort request corresponding to a workflow;
cause the first computing device to display a first user interface comprising a plurality of first user interface elements, the first user interface corresponding to a first workflow step of a work effort related to the work effort request and the workflow;
receive, from the first computing device and through the first user interface, a first trigger associated with one or more of the first plurality of user interface elements;
based on the first trigger, execute the workflow engine to perform at least a first workflow action; and
responsive to performing at least the first workflow action, perform a first workflow transition to progress the work effort from the first workflow step to a second workflow step.

2. The workflow control server of claim 1, wherein the memory stores further computer-readable instructions that, when executed by the one or more processors, cause the workflow control server to:
based on performing the first workflow transition to progress the work effort to the second workflow step, cause a second computing device to display a second user interface comprising a plurality of second user interface elements, the second user interface corresponding to the second workflow step of the work effort related to the work effort request;
receive, from the second computing device and through the second user interface, a second trigger associated with one or more of the second plurality of user interface elements;
based on the second trigger, execute the workflow engine to perform at least a second workflow action; and
responsive to performing at least the second workflow action, perform a second workflow transition to conclude the work effort in the workflow.

3. The workflow control server of claim 2, wherein the memory stores further computer-readable instructions that, when executed by the one or more processors, cause the workflow control server to:
based on performing the second workflow transition to conclude the work effort in the workflow, cause a third computing device to display a third user interface comprising a plurality of third user interface elements, the third user interface corresponding to a workflow processing assessment interface;
receive, from the third computing device and through the third user interface, a third trigger associated with one or more of the third plurality of user interface elements; and
based on the third trigger, update one or more of the workflow engine and the workflow database.

4. The workflow control server of claim 3, wherein the memory stores further computer-readable instructions that, when executed by the one or more processors, cause the workflow control server to:
based on the third trigger, update the logical arrangement of the workflow steps, workflow actions, and workflow transitions of the one or more data tables of the workflow database.

5. The workflow control server of claim 4, wherein the memory further stores a workflow library, and wherein the workflow engine calls operations from the workflow library to perform the first workflow transition and the second workflow transition.

6. The workflow control server of claim 5, wherein the memory stores further computer-readable instructions that, when executed by the one or more processors, cause the workflow control server to:
based on the third trigger, update the workflow library and the workflow engine.

7. The workflow control server of claim 5, wherein the workflow library is configured based on the logical arrangement of the workflow steps, workflow actions, and workflow transitions of the one or more data tables of the workflow database.

8. One or more non-transitory computer-readable media storing instructions that, when executed by a computing device comprising one or more processors and memory storing at least a workflow engine and a workflow database, cause the computing device to:
con the workflow engine based on the workflow database, wherein the workflow database comprises one or more data tables including a logical arrangement of workflow steps, workflow actions, and workflow transitions;
receive, from a first computing device, a work effort request corresponding to a workflow;
cause the first computing device to display a first user interface comprising a plurality of first user interface elements, the first user interface corresponding to a first workflow step of a work effort related to the work effort request and the workflow;
receive, from the first computing device and through the first user interface, a first trigger associated with one or more of the first plurality of user interface elements;
based on the first trigger, execute the workflow engine to perform at least a first workflow action; and
responsive to performing at least the first workflow action, perform a first workflow transition to progress the work effort from the first workflow step to a second workflow step.

9. The one or more non-transitory computer-readable media of claim 8, storing additional instructions that, when executed by the computing device comprising the one or more processors and the memory storing at least the workflow engine and the workflow database, cause the computing device to:
based on performing the first workflow transition to progress the work effort to the second workflow step, cause a second computing device to display a second user interface comprising a plurality of second user interface elements, the second user interface corresponding to the second workflow step of the work effort related to the work effort request;
receive, from the second computing device and through the second user interface, a second trigger associated with one or more of the second plurality of user interface elements;
based on the second trigger, execute the workflow engine to perform at least a second workflow action; and
responsive to performing at least the second workflow action, perform a second workflow transition to conclude the work effort in the workflow.

10. The one or more non-transitory computer-readable media of claim 9, storing additional instructions that, when executed by the computing device comprising the one or more processors and the memory storing at least the workflow engine and the workflow database, cause the computing device to:
based on performing the second workflow transition to conclude the work effort in the workflow, cause a third computing device to display a third user interface comprising a plurality of third user interface elements, the third user interface corresponding to a workflow processing assessment interface;
receive, from the third computing device and through the third user interface, a third trigger associated with one or more of the third plurality of user interface elements; and
based on the third trigger, update one or more of the workflow engine and the workflow database.

11. The one or more non-transitory computer-readable media of claim 10, storing additional instructions that, when executed by the computing device comprising the one or more processors and the memory storing at least the workflow engine and the workflow database, cause the computing device to:
based on the third trigger, update the logical arrangement of the workflow steps, workflow actions, and workflow transitions of the one or more data tables of the workflow database.

12. The one or more non-transitory computer-readable media of claim 11, wherein the memory of the computing devices stores a workflow library, and wherein the workflow engine calls operations from the workflow library to perform the first workflow transition and the second workflow transition.

13. The one or more non-transitory computer-readable media of claim 12, storing additional instructions that, when executed by the computing device comprising the one or more processors and the memory storing at least the workflow engine and the workflow database, cause the computing device to:
based on the third trigger, update the workflow library and the workflow engine.

14. The one or more non-transitory computer-readable media of claim 12, wherein the workflow library is configured based on the logical arrangement of the workflow steps, workflow actions, and workflow transitions of the one or more data tables of the workflow database.

15. A method, comprising:
at a computing device comprising one or more processors and memory storing at least a workflow engine and a workflow database:
configuring the workflow engine based on the workflow database, wherein the workflow database comprises one or more data tables including a logical arrangement of workflow steps, workflow actions, and workflow transitions;
receiving, from a first computing device, a work effort request corresponding to a workflow;
causing the first computing device to display a first user interface comprising a plurality of first user interface elements, the first user interface corresponding to a first workflow step of a work effort related to the work effort request and the workflow;
receiving, from the first computing device and through the first user interface, a first trigger associated with one or more of the first plurality of user interface elements;
based on the first trigger, executing the workflow engine to perform at least a first workflow action; and
responsive to performing at least the first workflow action, performing a first workflow transition to progress the work effort from the first workflow step to a second workflow step.

16. The method of claim 15, further comprising:
based on performing the first workflow transition to progress the work effort to the second workflow step, causing a second computing device to display a second user interface comprising a plurality of second user interface elements, the second user interface corresponding to the second workflow step of the work effort related to the work effort request;
receiving, from the second computing device and through the second user interface, a second trigger associated with one or more of the second plurality of user interface elements;
based on the second trigger, executing the workflow engine to perform at least a second workflow action; and
responsive to performing at least the second workflow action, performing a second workflow transition to conclude the work effort in the workflow.

17. The method of claim 16, further comprising:
based on performing the second workflow transition to conclude the work effort in the workflow, causing a third computing device to display a third user interface comprising a plurality of third user interface elements, the third user interface corresponding to a workflow processing assessment interface;
receiving, from the third computing device and through the third user interface, a third trigger associated with one or more of the third plurality of user interface elements; and
based on the third trigger, updating one or more of the workflow engine and the workflow database.

18. The method of claim 17, further comprising:
based on the third trigger, updating the logical arrangement of the workflow steps, workflow actions, and workflow transitions of the one or more data tables of the workflow database.

19. The method of claim 18, wherein the memory of the computing device further stores a workflow library, and wherein the workflow engine calls operations from the workflow library to perform the first workflow transition and the second workflow transition.

20. The method of claim 19, wherein the workflow library is configured based on the logical arrangement of the workflow steps, workflow actions, and workflow transitions of the one or more data tables.
